(19) United States
(12) Patent Application Publication
(10) Pub. No.: US 2008/0124247 A1
(43) Pub. Date: May 29, 2008

(54) Chip element for micro chemical system and micro chemical system using the chip element

(75) Inventors: Yoshinori Matsuoka, Tokyo (JP); Jun Yamaguchi, Tokyo (JP); Takashi Fukuzawa, Tokyo (JP); Akihiko Hattori, Tokyo (JP); Takehiko Kitamori, Tokyo (JP)

Correspondence Address: COHEN PONTANI LIEBERMAN & PAVANE LLP, Suite 1210, 551 Fifth Avenue, New York, NY, 10176, US

(73) Assignee: Nippon Sheet Glass Company Limited, Tokyo (JP)

(21) Appl. No.: 11/983,917

(22) Filed: Nov. 13, 2007

Related U.S. Application Data
(63) Continuation of application No. PCT/JP2006/304209, filed on Feb. 28, 2006.

(30) Foreign Application Priority Data
May 12, 2005 (JP) 2005-140136

(51) Int. Cl. G01N 21/64; G01N 21/00

(52) U.S. Cl. 422/82.08; 422/82.05

(57) ABSTRACT

There are provided a chip for micro chemical systems which can obviate the need of alignment at every measurement and can improve the measurement sensitivity and reduce the variation of measurement, and a micro chemical system using the chip. A thermal lens spectrometry system 10 comprises: a micro chemical chip 2 having a groove 1 into which a sample solution is injected; a rod lens 3 disposed on the micro chemical chip 2 at a predetermined spacing above the groove 1; a lens holder 9 disposed above the micro chemical chip 2; a securing section 4; an optical fiber 5; a ferrule 6 secured by the securing section 4 above the rod lens 3; a light source unit 7 connected to the optical fiber 5, and a detection device 8 disposed below the micro chemical chip 2. The securing section 4 comprises a seating 32 laid on the micro chemical chip 2, and a metal split sleeve 33 for fitting the ferrule 6 and the lens holder 9 at the outside thereof.

### RELATED APPLICATION

This application is a U.S. Continuation Application of International Application PCT/JP2006/304209 filed 28 Feb. 2006.

### TECHNICAL FIELD

The present invention relates to a chip element for micro chemical systems and a micro chemical system using the chip element.

### BACKGROUND ART

In consideration of the rapidity of chemical reactions, and the need to carry out reactions using very small amounts, on-site chemical analyses, and the like, integration technologies for carrying out chemical reactions in a very small space has been focused upon and research into these technologies has been vigorously conducted.

One of such integration technologies is a micro chemical system for performing the mixing, reaction, separation, extraction, detection, and the like of a liquid specimen using a micro chemical chip.

For example, as shown in FIG. 8, a micro chemical system 1000 comprises: a plate-shaped member with a channel 120, the channel of which being filled with a sample solution; an optical fiber with lens 100 being disposed above the plate-shaped member with the channel 120 and provided with a lens at the tip end thereof; a light source unit 110 being connected to the optical fiber with lens 100 and adapted to irradiate excitation light onto the sample solution in the channel of the plate-shaped member with channel 120 through the optical fiber with lens 100 and to irradiate detection light to a thermal lens produced in the sample solution by the irradiated excitation light; and a detection device 130 being disposed below the plate-shaped member with channel 120 and adapted to detect the detection light through the thermal lens produced in the sample solution in the channel of the plate-shaped member with channel 120 by the excitation light.

The optical fiber with lens 100 comprises a lens 101 being bonded to the plate-shaped member with the channel 120 through an adhesive, optical fibers 102 being connected at one end to the lens 101 and at the other end to the light source unit 110 and configured to have an FC connector 103 located midway therebetween, and an annular member 105 for securing the optical fibers 102 through a ferrule 104.

The FC connector 103 comprises FC plugs 106, 107 and an adaptor 108 adapted to respectively secure the FC plugs 106, 107, and the FC plugs 106, 107 are respectively screwed into the adaptor 108 thereby joining the optical fibers 102.

The light source unit 110 comprises: a light source for excitation light 111 for outputting excitation light; a modulator 112 being connected to the light source for excitation light 111 and adapted to modulate the excitation light output from the light source for excitation light 111; a light source for detection light 113 for outputting detection light; and a two-wavelength multiplexing device 115 being connected to the light source for excitation light 111 and the light source for detection light 113 respectively via the optical fibers 114 and also connected to the optical fibers 102 of the optical fiber with lens 100, and adapted to multiplex the excitation light output from the light source for excitation light 111 and the detection light output from the light source for detection light 113 and to make these multiplexed excitation light and detection light respectively enter into the optical fibers 102.

The plate-shaped member with channel (micro chemical chip) 120 comprises: an upper glass substrate 121, a middle glass substrate 122; and a lower glass substrate 123, which are piled and bonded in three layers in that order from the side of the optical fiber with lens 100. The middle glass substrate 122, which is the middle layer of the micro chemical chip 120, is provided with a channel 124 through which the sample solution is fed during the operation by the micro chemical system 1000 such as mixing, stirring, synthesis, separation, extraction, and detection of the sample solution.

The detection device 130 comprises: a wavelength filter 131 being disposed at a position to face the channel 124 of the micro chemical chip 120 at a predetermined spacing and to be opposed to the optical fiber with lens 100, and adapted to separate the multiplexed excitation light and detection light thereby selectively passing only the detection light; a photoelectric converter 132 being disposed at a position to face the channel 124 at a predetermined spacing, below the wavelength filter 131 and adapted to detect the detection light, and a computer 134 connected to the photoelectric converter 132 via a lock-in amplifier 133 (for example, see Japanese Laid-Open Patent Publication (Kokai) No. 2004-117302, and Japanese Laid-Open Patent Publication (Kokai) No. 2002-214175).

However, since the lens 101 is bonded to the micro chemical chip 120 via an adhesive, the adhesive absorbs light passing through the lens 101, thereby inhibiting the travel of light. Further, variations in the composition, reactions, etc. of the adhesive will cause distortion (striae), and it has been the case that this distortion (striae) inhibits the travel of light. Furthermore, the thickness of the adhesive cannot be controlled, and therefore it is very difficult to control the focus position of the lens 101.

In the micro chemical system 1000, the micro chemical chip 120 will need replacement when the micro chemical chip 120 is damaged or soiled, or when the use of the micro chemical system 1000 is changed. When replacing the micro chemical chip 120, the micro chemical chip 120 needs to be separated from the light source unit 110, and when separating the micro chemical chip 120 from the light source unit 110 at the middle point of the optical fibers 102, an alignment with submicron accuracy is needed to connect the optical fibers 102 by the FC connector 103. Thus, it has been the case that the connection efficiency changes every time attaching/detaching the optical fibers 102, making it impossible to perform stable measurements.

Further, when separating the micro chemical chip 120 from the light source unit 110 between the lens 101 and the optical fibers 102, the alignment of the lens 101 with the optical fibers 102 is performed by attaching the annular member 105 to a predetermined position outside the lens 101 at every time attaching/detaching the optical fibers 102. At this time, since the lens 101 is very small, it has been the case that the annular member 105 cannot be attached precisely to the predetermined position outside of the lens 101. Further, since the tolerance between the lens 101 and the annular member 105 is small, it may have been the case that even a minor misoperation upon attaching the annular member 105 causes a damage of the lens 101.

Furthermore, the attachment position of the lens 101 and that of the optical fibers 102 are separately determined with reference to a groove 124 in the micro chemical chip 120. Therefore, if the attachment position of the lens 101 is deviated, the attachment position of the optical fibers 102 will be determined without taking into consideration this deviation of the attachment position of the lens 101, and thus it may have been the case that the focus position of the lens 101 is significantly deviated.

The present invention provides a chip element for micro chemical systems, which can obviate the need of alignment at every measurement, and improve measurement sensitivity and reduce the variation of measurement, and a micro chemical system using the chip element.

### DISCLOSURE OF THE INVENTION

To attain the above object, according to a first aspect of the present invention, there is provided a chip element for micro chemical systems, comprising a chip having a groove into which a liquid specimen is injected, and a lens adapted to concentrate light propagated from a light source through an optical fiber to the liquid specimen, the chip element for micro chemical systems characterized by comprising a lens holding section adapted to hold the lens and a securing section adapted to secure the lens holding section and an end part of the optical fiber to the chip.

In the first embodiment, the end part of the optical fiber can be detachably mounted to the securing section.

In the first embodiment, the lens holding section can have a hole into which the lens is inserted.

In the first embodiment, the lens holding section can be a tube of a cylindrical shape.

In the first embodiment, the hole into which the lens is inserted can be of a circular shape.

In the first embodiment, said chip element for micro chemical systems can further comprise a seating with which the lens holding section is secured to the chip.

In the first embodiment, the distance between the focus position of the lens and the center point of the groove with respect to the depth direction of the groove can be within 15% of the depth of the groove.

In the first embodiment, the distance between the focus position of the lens and the center point of the groove with respect to the depth direction of the groove can be within 10% of the depth of the groove.

In the first embodiment, the distance between the focus position of the lens and the center point of the groove with respect to the width direction of the groove can be within 20% of the width of the groove.

In the first embodiment, the distance between the focus position of the lens and the center point of the groove with respect to the width direction of the groove can be within 15% of the width of the groove.

In the first embodiment, the securing section can secure an end part of the optical fiber via an optical fiber holding section adapted to hold the optical fiber.

In the first embodiment, the end part of the optical fiber can be secured by bringing the optical fiber holding section into abutment with the lens holding section.

In the first embodiment, the optical fiber holding section can be a ferrule.

In the first embodiment, the securing section can have a hole into which the optical fiber holding section is inserted.

In the first embodiment, the securing section can have a tube of a cylindrical shape.

In the first embodiment, the hole into which the optical fiber is inserted, can be of a circular shape.

In the first embodiment, the change amount of the distance between the lens and the end part of the optical fiber with respect to the depth direction of the groove can be within a predetermined value at every time mounting the lens and the end part of the optical fiber.

In the first embodiment, the predetermined value can be a value of 15% of the depth of the groove multiplied by a lens magnification of the lens.

In the first embodiment, the lens magnification can be the value of the distance between the principal point of the lens and the end face of the optical fiber divided by the distance between the principal point of the lens and the focus position of the lens.

In the first embodiment, the change amount of the distance between the lens and the end part of the optical fiber with respect to the width direction of the groove can be within a predetermined value at every time mounting the lens and the end part of the optical fiber.

In the first embodiment, the predetermined value can be a value of 20% of the width of the groove multiplied by the lens magnification of the lens.

In the first embodiment, the lens magnification can be a value of the distance between the principal point of the lens and an end face of the optical fiber divided by the distance between the principal point of the lens and the focus position of the lens.

In the first embodiment, the lens holding section can have an opening through which an adhesive is fed.

In the first embodiment, the securing section can have an opening through which an adhesive is fed.

In the first embodiment, the lens can have a chromatic aberration.

In the first embodiment, the lens can be a rod lens.

In the first embodiment, the chip can be made of glass.

In the first embodiment, the optical fiber can be a single mode at the wavelengths of the excitation light and the detection light.

To attain the above object, according to a second aspect of the present invention, there is provided a micro chemical system characterized by using the chip element for micro chemical systems of the first embodiment of the present invention.

In the second embodiment, the micro chemical system can include a thermal lens spectrometry system and/or a fluorescent detection system.

### BRIEF DESCRIPTION OF THE DRAWINGS

FIG. 1 is a view schematically showing the configuration of a micro chemical system according to an embodiment of the present invention.

FIG. 2 is an enlarged sectional view of the micro chemical chip in FIG. 1.

FIG. 3 is a diagram useful in explaining the lens magnification of a graded refractive index rod lens in FIG. 1.

FIG. 4 is a view schematically showing the configuration of a securing section in FIG. 1.

FIG. 5 is a view schematically showing the configuration of a variation of the securing section of FIG. 4.

FIG. 6 is a view schematically showing the configuration of another variation of the securing section of FIG. 4.

FIG. 7 is a view schematically showing the configuration of a variation of the micro chemical system of FIG. 1.

FIG. 8 is a view schematically showing a conventional micro chemical system configuration.

### BEST MODE FOR CARRYING OUT THE INVENTION

The present invention will now be described in detail with reference to the drawings showing preferred embodiments thereof.

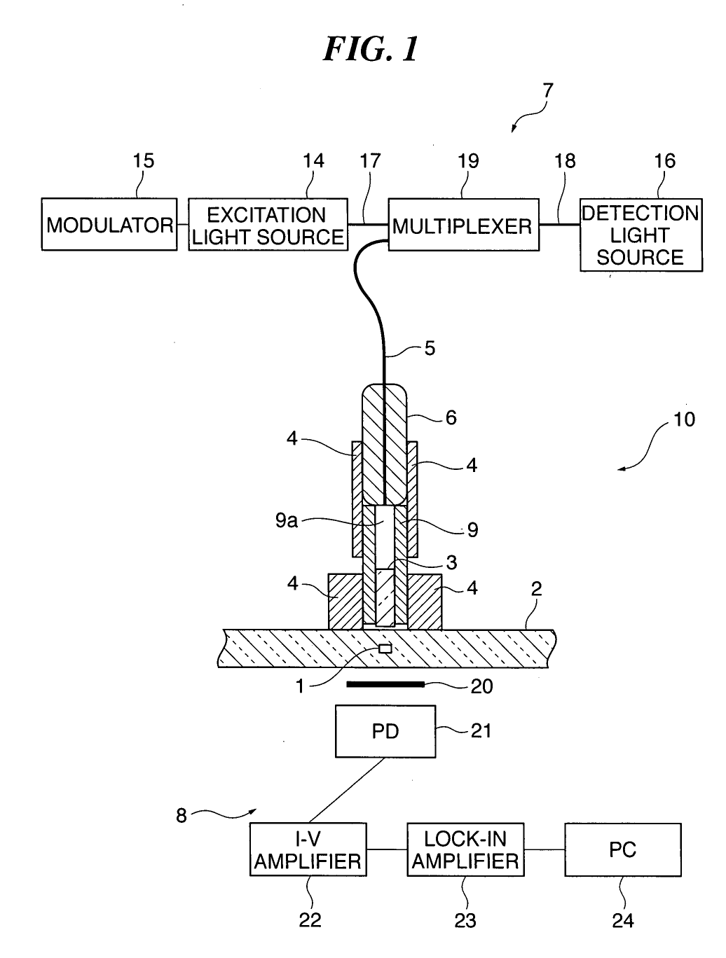

FIG. 1 is a view schematically showing the configuration of a micro chemical system according to an embodiment of the present invention.

In FIG. 1, a thermal lens spectrometry system 10 as a micro chemical system comprises: a micro chemical chip 2 having a groove 1 into which sample solution is injected; a graded refractive index rod lens 3 of a 1 mm diameter cylindrical shape, such as SELFOC (registered trade mark), which is disposed on the micro chemical chip 2 at a predetermined spacing above the groove 1, and adapted to concentrate the light propagated from a below described optical fiber 5 onto the groove 1; a lens holder 9 of a 2.5 mm outer diameter tube shape, which is disposed above the micro chemical chip 2, and configured to have a circular hole 9a for fitting the graded refractive index rod lens 3 at the outside thereof; a securing section 4 being disposed above the micro chemical chip 2 and adapted to secure the lens holder 9 and a below described ferrule 6; a single-mode optical fiber 5 being disposed above the graded refractive index rod lens 3 and adapted to propagate light to the graded refractive index rod lens 3; a ferrule 6 of a 2.5 mm outer diameter, being secured by the securing section 4 above the graded refractive index rod lens 3 and adapted to hold the optical fiber 5; a light source unit 7 being connected to the optical fiber 5 and adapted to irradiate an excitation light to the sample solution in the groove 1 of the micro chemical chip 2 via the optical fiber 5 and to irradiate a detection light to the thermal lens generated in the sample solution by the irradiated excitation light; and a detection device 8 being disposed below the micro chemical chip 2 and adapted to detect the detection light through the thermal lens generated in the sample solution in the groove 1 of the micro chemical chip 2 by the excitation light irradiated from the light source unit.

The micro chemical chip 2 comprises the groove 1 through which sample solution is fed during the operation by the thermal lens spectrometry system 10, such as mixing, stirring, synthesis, separation, extraction, and detection.

The material for the micro chemical chip 2 can be glass in the aspect of durability and chemical resistance. Further, considering the use for samples from living bodies such as cell samples, for example for DNA analysis, the material can be glass having excellent acid and alkali resistance, specifically borosilicate glass, soda lime glass, aluminoborosilicate glass, silica glass, and the like. However, organic materials such as plastics can also be used by limiting the use thereof.

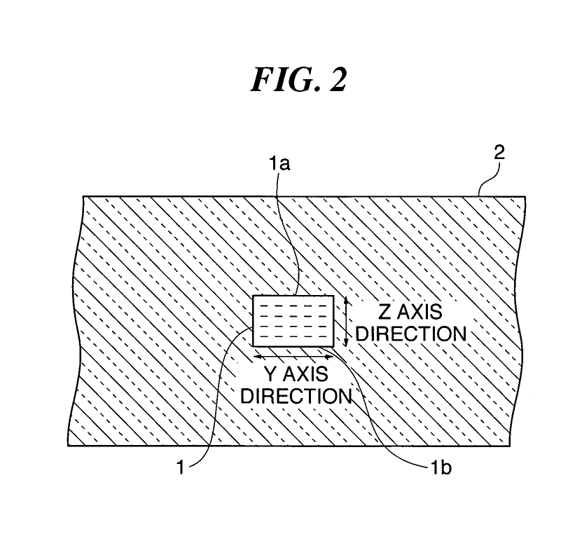

The graded refractive index rod lens 3 has a magnification of 5 in the depth direction of the groove 1 (X axis direction in FIG. 2) and a magnification of 3 in the width direction of the groove 1 (Y axis direction in FIG. 2).

The light source unit 7 comprises: a light source for excitation light 14 adapted to output an excitation light; a modulator 15 being connected to the light source for excitation light 14 and adapted to modulate the excitation light output from the light source for excitation light 14; a light source for detection light 16 adapted to output a detection light; a multiplexer 19 being connected to the light source for excitation light 14 and the light source for detection light 16 respectively via the optical fibers 17, 18 and also connected to the optical fiber 5, and adapted to multiplex the excitation light output from the light source for excitation light 14 and the detection light output from the detection light source 16 and to make these multiplexed excitation light and detection light respectively enter into the optical fiber 5.

In the light source unit 7, a dichroic mirror can be used in the place of the multiplexer 19, to multiplex the excitation light output from the light source for excitation light 14 and the detection light output from the light source for detection light 16 and to make these multiplexed excitation light and detection light respectively enter into the optical fiber 5.

The detection device 8 comprises: a wavelength filter 20 being disposed at a position to face the groove 1 of the micro chemical chip 2 at a predetermined spacing and to be opposed to the optical fiber 5, and adapted to separate the multiplexed excitation light and detection light and to selectively pass only the detection light; a photoelectric converter (photodiode) 21 being disposed below the wavelength filter 20 at a position to face the groove 1 at a predetermined spacing and adapted to detect the detection light; and a computer 24 connected to the photoelectric converter 21 via an I-V amplifier 22 and a lock-in amplifier 23.

In the detection device 8, a predetermined member in which a pinhole for selectively passing only part of the detection light is formed may be placed on the optical path of the detection light and disposed on the upstream side of the photoelectric converter 21.

The signal obtained from the photoelectric converter 21 is sent to the lock-in amplifier 23, which performs synchronization with the modulator 15 which modulates the excitation light, via the I-V amplifier 22 and is then analyzed at the computer 24.

Since the hole 9a provided in the lens holder 9 is circular, it is possible to reduce the tolerance against the graded refractive index rod lens 3 of a cylindrical shape, and to improve the finishing accuracy of the hole 9a thereby improving the positional accuracy of the graded refractive index rod lens 3.

Further, since the securing section 4 secures the graded refractive index rod lens 3 so as to be opposed to the micro chemical chip 2 via the lens holder 9, the need of applying an adhesive between the micro chemical chip 2 and the end face of the graded refractive index rod lens 3 is obviated thereby making it possible to fully eliminate the blocking of the travel of light by the adhesive.

As the result of the ferrule 6 being mounted to the securing section 4, the micro chemical chip 2 and the light source unit 7 are connected via the graded refractive index rod lens 3 and the optical fiber 5. Further, as the result of the ferrule 6 mounted to the securing section 4 being detached from the securing section 4, the micro chemical chip 2 and the light source unit 7 are separated at between the graded refractive index rod lens 3 and the optical fiber 5.

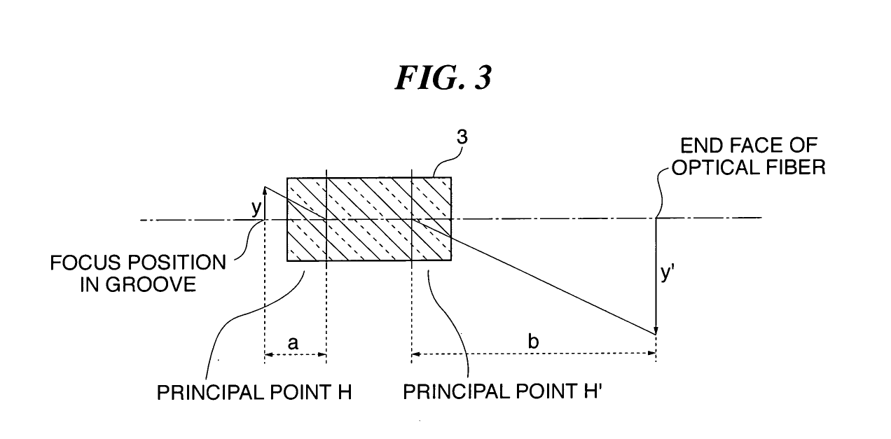

The permissible range of the alignment of the graded refractive index rod lens 3 and the optical fiber 5 increases as the lens magnification of the graded refractive index rod lens 3 increases. For example, when the lens is set at 5-fold magnification, since the fifth part of the positional deviation between the graded refractive index rod lens 3 and the optical fiber 5 corresponds to the deviation of the focus position of the graded refractive index rod lens 3 in the groove 1, suppressing the deviation of the focus position of the graded refractive index rod lens 3 in the groove 1 to be not more than 10 μm may be attained by suppressing the positional deviation between the graded refractive index rod lens 3 and the optical fiber 5 to be not more than 50 μm. Since the permissible value of the positional deviation between the graded refractive index rod lens 3 and the optical fiber 5 is larger than the permissible value in the case that the micro chemical chip 2 and the light source unit 7 is separated at other than between the graded refractive index rod lens 3 and the optical fiber 5, it is possible to easily suppress the variation of measurement. Moreover, the lens magnification of the graded refractive index rod lens 3 is, as shown in FIG. 3, defined as a value of distance “b” between the principal point H′ of the graded refractive index rod lens 3 and the end face (radiation face) of the optical fiber 5 divided by the distance “a” between the principal point H of the graded refractive index rod lens 3 and the focus position of the graded refractive index rod lens 3 in the groove 1, that is, the size y′ of an image in the end face of the graded refractive index rod lens 3 divided by the size y of the image at the focus position of the graded refractive index rod lens 3 in the groove 1.

According to the thermal lens spectrometry system 10 of the above described configuration, since the graded refractive index rod lens 3 is held by the lens holder 9 and the lens holder 9 is secured by the securing section 4, there is no need of applying an adhesive on the end face of the graded refractive index rod lens 3, and also the holding position of the graded refractive index rod lens 3 with respect to the lens holder 9 can be adjusted even without adjusting the focus position of the graded refractive index rod lens 3 by a spacer between the micro chemical chip 2 and the graded refractive index rod lens 3, or the thickness of the adhesive applied to the graded refractive index rod lens 3, making it possible to easily adjust the focus position of the graded refractive index rod lens 3 in the Z axis direction.

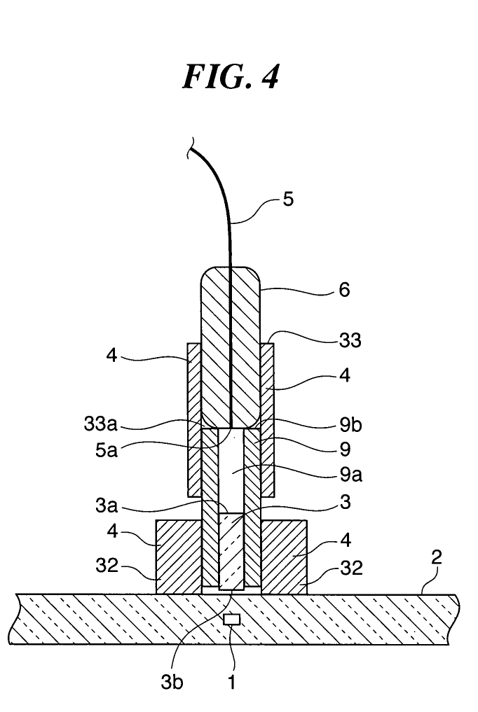

FIG. 4 is a view schematically showing the configuration of the securing section in FIG. 1.

In FIG. 4, the securing section 4 comprises: a seating 32 made of for example glass, being laid on the micro chemical chip 2 and configured to have a large bottom area (contact area with the micro chemical chip 2) and to fit the lens holder 9 at the outside thereof; and a metal split sleeve 33 of a tube shape, being configured to have a circular hole 33a for fitting the ferrule 6 and the lens holder 9 at the outsides thereof.

Moreover, since the metal split sleeve 33 has a small size and light weight, it imposes small load onto the micro chemical chip 2 and also can be mounted even in a small area. Further, when the clearance between the inner periphery of the hole 33a in the metal split sleeve 33 and the outer periphery of the lens holder 9 (ferrule 6) is too large, the lens holder 9 (ferrule 6) is likely to be detached from the metal split sleeve 33, and when the clearance is too small, it becomes difficult to secure the lens holder 9 (ferrule 6) to the metal split sleeve 33, the diameter (inner diameter) of the hole 33a of the metal split sleeve 33 is set such that the clearance is an appropriate value.

Furthermore, since the seating 32 (securing section 4) has a large bottom area (contact area with the micro chemical chip 2), it is possible to stably hold the graded refractive index rod lens 3 in a vertical state with respect to the micro chemical chip 2.

Further, since the position adjustment of the graded refractive index rod lens 3 is performed after the graded refractive index rod lens 3 is secured to the lens holder 9, it is possible to obviate the need of directly holding the graded refractive index rod lens 3 which is small in size and to perform the positional adjustment of the graded refractive index rod lens 3 easily and accurately.

Further, since the lens holder 9 is disposed above the seating 32, the positional adjustment of the graded refractive index rod lens 3 with respect to Z axis direction can be performed with ease.

Hereinafter, the method of securing the graded refractive index rod lens 3 by the securing section 4 will be described.

The graded refractive index rod lens 3 is bonded to the lens holder 9 such that the distance between the upper face 3a of the graded refractive index rod lens 3 and the end face 9b of the lens holder 9 (an end face 5a of the optical fiber 5) is for example 2.5 mm; seating 32 is bonded to the micro chemical chip 2 while performing the optical axis adjustment in Y axis direction (Y axis aligning) of the lens holder 9 and the seating 32; the lens holder 9 is bonded to the seating 32 while performing the optical axis adjustment of the lens holder 9 in Z axis direction (Z axis aligning) such that the distance between the lower face 3b of the graded refractive index rod lens 3 and the center point of the groove 1 is for example 0.7 mm that is a corresponding value in the air; and the ferrule 6 is forced into a position to come into contact with the lens holder 9. Thus, since the ferrule 6 is forced into a position to come into contact with the lens holder 9 to secure the end part of the optical fiber 5, it is possible to make the positional deviation in Z axis direction of the optical fiber 5 to be not more than 10 μm (positional repeatability of the optical fiber 5 is improved), and thereby to make the deviation of the intensity of the thermal lens signal to be not more than 5%.

Further, since the lens holder 9 and the seating 32 are separated, it is possible to perform Y axis centering and Z axis centering separately, and to adjust the position of the end part of the optical fiber 5 with respect to the graded refractive index rod lens 3 after securing the graded refractive index rod lens 3 above the micro chemical chip 2.

Further, according to the method of securing the graded refractive index rod lens 3, since the lens holder 9 to which the graded refractive index rod lens 3 is bonded is subjected to positional adjustment (optical axis adjustment), there is no need of performing positional adjustment while holding the graded refractive index rod lens 3 in the circular hole 9a, and thus it is possible to perform accurate positional adjustment of the graded refractive index rod lens 3, and thereby to prevent the variations in measurement and the decline of measurement sensitivity caused by the variation of glass thickness of the micro chemical chip 2 during manufacturing.

Table 1 shows the relationship between the distance between the center point of the groove 1 and the focus position of the graded refractive index rod lens 3 (with respect to the excitation light) and the intensity of the thermal lens signal. As shown in FIG. 2, when an etching chip or a blast chip of which the lower part of the groove 1 is flat is used as the micro chemical chip 2, the groove width is given as the average of the width of the upper part 1a and the width of the lower part 1b of the groove 1. Moreover, when an etching chip of which the lower part of the groove 1 is round is used as the micro chemical chip 2, the groove width is given as the width of the upper part 1a of the groove 1.

TABLE 1

| Distance between the center point of the | |
|---|---|
| groove 1 and the focus position of the | Intensity of thermal lens |
| excitation light | signal |
| 0 | Maximum |
| 10% of groove depth with respect to Z | 95% of maximum |
| axis direction | |
| 15% of groove depth with respect to Z | 90% of maximum |
| axis direction | |
| 0 | Maximum |
| 15% of groove depth with respect to Y | 95% of maximum |
| axis direction | |
| 20% of groove depth with respect to Y | 90% of maximum |
| axis direction | |

From Table 1, it is seen that to maintain the intensity of the thermal lens signal to be not less than 90% of the intensity (maximum) when the focus position of the excitation light is at the center point of the groove 1, the distance between the center point of the groove 1 and the focus position of the excitation light with respect to Z axis direction needs to be within 15% of the groove depth; and also to maintain the intensity of the thermal lens signal to be not less than 95% of the intensity (maximum) when the focus position of the excitation light is at the center point of the groove 1, the distance between the center point of the groove 1 and the focus position of the excitation light with respect to Z axis direction needs to be within 10% of the groove depth.

Further, it is seen that to maintain the intensity of the thermal lens signal to be not less than 90% of the intensity (maximum) when the focus position of the excitation light is at the center point of the groove 1, the distance between the center point of the groove 1 and the focus position of the excitation light with respect to Y axis direction needs to be within 20% of the groove depth; and also to maintain the intensity of the thermal lens signal to be not less than 95% of the intensity (maximum) when the focus position of the excitation light is at the center point of the groove 1, the distance between the center point of the groove 1 and the focus position of the excitation light with respect to Y axis direction needs to be within 15% of the groove depth.

Further, from Table 1, it is seen that as to the distance between the center point of the groove 1 and the focus position of the excitation light, the distance with respect to Z axis direction has greater influence on the intensity (measurement) of the thermal lens signal than the distance with respect to Y axis direction, that is, the positional accuracy with respect to Z axis direction is more strictly required than the positional accuracy with respect to Y axis direction.

According to the present embodiment, since the securing section 4 secures the lens holder 9 and the end part of the optical fiber 5 to the micro chemical chip 2, it is possible to secure the graded refractive index rod lens 3 and the end part of the optical fiber 5 easily and accurately, and to obviate the need of alignment at every measurement, thereby improving the measurement sensitivity and reducing the variation of measurement.

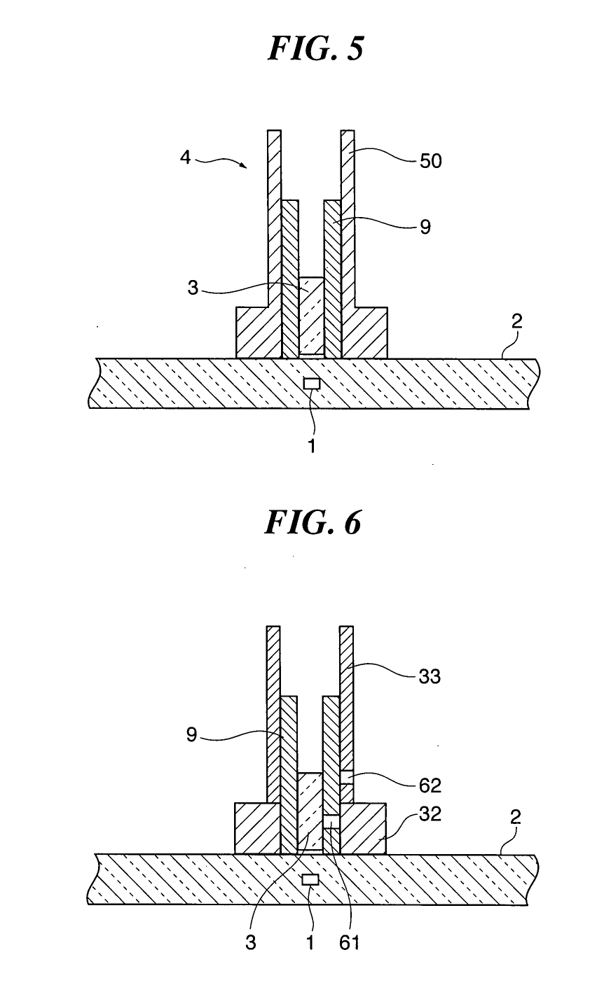

In the present embodiment, the seating 32 is provided below the metal split sleeve 33, but this invention is not limited thereto and as shown in FIG. 5, a securing member 50 may be used in which the metal split sleeve 33 and the seating 33 are integrated into one piece is provided. This will make the securing member 50 to be the only component of the securing section 4, thus enabling cost reduction.

In the present embodiment, the seating 32 is provided below the metal split sleeve 33 via a predetermined spacing, but this invention is not limited thereto and, as shown in FIG. 6, the lower face of the metal split sleeve 33 may be in contact with the upper face of the seating 33, and further there is provided an opening 61 through which an adhesive is poured into, the adhesive being used for bonding the graded refractive index rod lens 3 to the lens holder 9, or an opening 62 through which an adhesive is poured into, the adhesive being used for bonding the lens holder 9 to the metal split sleeve 33.

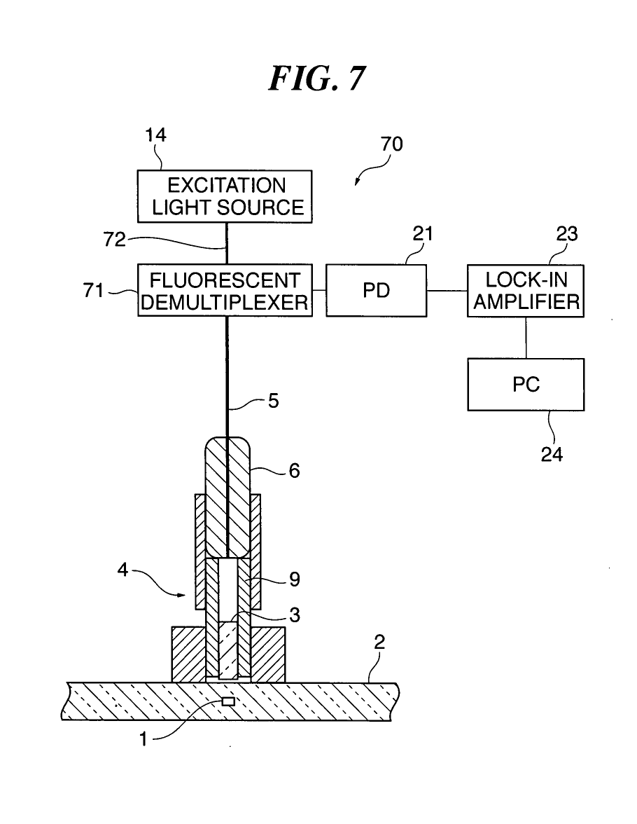

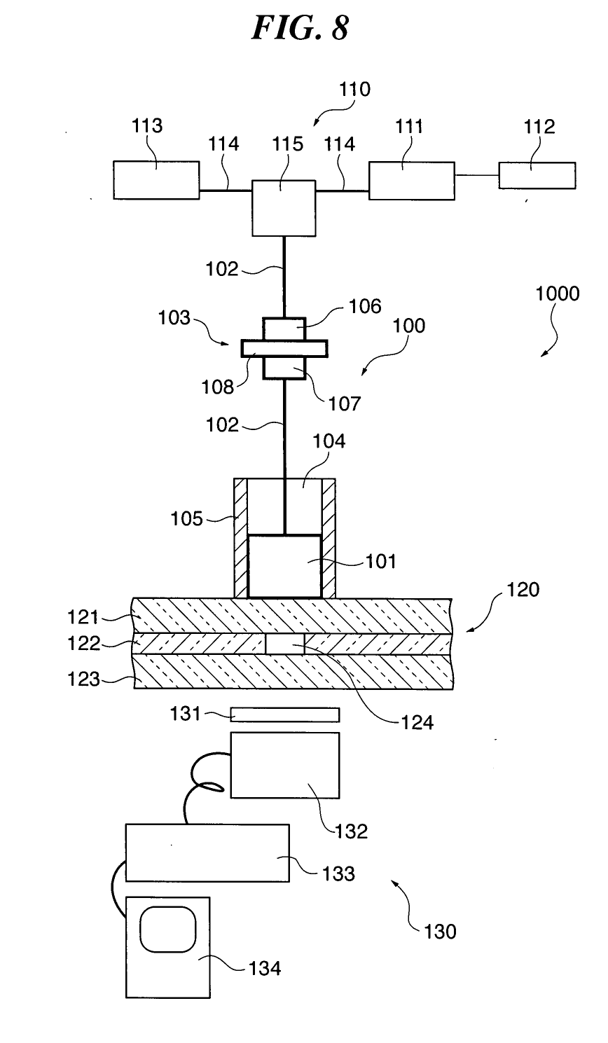

In the present embodiment, the thermal lens spectrometry system 10 is used as the micro chemical system, but this invention is not limited thereto and, as shown in FIG. 7, a fluorescent detection device 70 may be used, which comprises a fluorescent demultiplexer 71 connected to the optical fiber 5, an excitation light source 14 connected to the fluorescent demultiplexer 71 via the optical fiber 72, a photoelectric converter (photodiode) 21 connected to the fluorescent demultiplexer 71, and a computer 24 connected to the photoelectric converter 21 via a lock-in amplifier 23.

In the present embodiment, the graded refractive index rod lens 3 is used as the lens, but this invention is not limited thereto and other types of lenses may be used.

In the present embodiment, the metal split sleeve 33 is used for the securing section 4, but this invention is not limited thereto and other types of tubes may be used.

### INDUSTRIAL APPLICABILITY

According to the chip element for micro chemical systems of the first embodiment of the present invention, since the securing section secures the lens holding section and the end part of the optical fiber to the chip, it is possible to obviate the need of applying an adhesive between the chip and the end face of the lens, thereby fully eliminating the blocking of the travel of light caused by the adhesive; to secure the lens and the end part of the optical fiber with ease and accuracy, thereby obviating the need of alignment at every measurement; and thus to improve the measurement sensitivity and reduce the variation of measurement.

According to the chip element for micro chemical systems of the first embodiment of the present invention, since the end part of the optical fiber is detachably mounted to the securing section, it is possible to easily perform the connection and disconnection of the optical fiber and the chip.

According to the chip element for micro chemical systems of the first embodiment of the present invention, since the lens holding section has a hole through which the lens is inserted, it is possible to easily hold and secure the lens.

According to the chip element for micro chemical systems of the first embodiment of the present invention, since the hole through which the lens is inserted is circular, it is possible to improve the finishing accuracy of the hole thereby improving the positional accuracy of the lens.

According to the chip element for micro chemical systems of the first embodiment of the present invention, since the seating secures the lens holding section to the chip, it is possible to adjust the position of the lens with respect to the groove of the chip and the position of the end part of the optical fiber with respect to the lens, after securing the lens to the lens holding section.

According to the chip element for micro chemical systems of the first embodiment of the present invention, since the distance between the focus position of the lens and the center point of the groove with respect to the depth direction of the groove is within 15% of the depth of the groove, it is possible to reduce the deviation of the intensity of the thermal lens signal.

According to the chip element for micro chemical systems of the first embodiment of the present invention, since the distance between the focus position of the lens and the center point of the groove with respect to the depth direction of the groove is within 10% of the depth of the groove, it is possible to further reduce the deviation of the intensity of the thermal lens signal.

According to the chip element for micro chemical systems of the first embodiment of the present invention, since the distance between the focus position of the lens and the center point of the groove with respect to the width direction of the groove is within 20% of the width of the groove, it is possible to reduce the deviation of the intensity of the thermal lens signal.

According to the chip element for micro chemical systems of the first embodiment of the present invention, since the distance between the focus position of the lens and the center point of the groove with respect to the width direction of the groove is within 15% of the width of the groove, it is possible to further reduce the deviation of the intensity of the thermal lens signal.

According to the chip element for micro chemical systems of the first embodiment of the present invention, since the end part of the optical fiber is secured by the optical fiber holding section being in abutment with the lens holding section, it is possible to improve the position repeatability of the optical fiber.

According to the chip element for micro chemical systems of the first embodiment of the present invention, since the securing section has a hole into which the optical fiber holding section is inserted, it is possible to detachably secure the end part of the optical fiber to the securing section with ease.

According to the chip element for micro chemical systems of the first embodiment of the present invention, since the hole into which the optical fiber holding section is inserted is circular, it is possible to improve the finishing accuracy of the hole and thereby positional accuracy of securing the end part of the optical fiber.

According to the chip element for micro chemical systems of the first embodiment of the present invention, since the change amount of the distance between the lens and the end part of the optical fiber with respect to the depth direction of the groove, at every time mounting the lens and the end part of the optical fiber, is within a predetermined value, it is possible to further reduce the variation of measurement.

According to the chip element for micro chemical systems of the first embodiment of the present invention, since the change amount of the distance between the lens and the end part of the optical fiber with respect to the width direction of the groove, at every time mounting the lens and the end part of the optical fiber, is within a predetermined value, it is possible to further reduce the variation of measurement.

According to the chip element for micro chemical systems of the second embodiment of the present invention, since the securing section secures the lens holding section and the end part of the optical fiber, it is possible to obviate the need of alignment at every measurement and to improve the measurement sensitivity and reduce the variation of measurement.

1. A chip element for micro chemical systems, comprising a chip having a groove into which a sample solution is injected, and a lens adapted to concentrate light propagated from a light source through an optical fiber to said sample solution, the chip element for micro chemical systems characterized by comprising a lens holding section adapted to hold said lens, and a securing section adapted to secure said lens holding section and an end part of said optical fiber to said chip.

2. The chip element for micro chemical systems according to claim 1, characterized in that the end part of said optical fiber is detachably mounted to said securing section.

3. The chip element for micro chemical systems according to claim 1, characterized in that said lens holding section has a hole into which said lens is inserted.

4. The chip element for micro chemical systems according to claim 3, characterized in that said lens holding section is a tube of a cylindrical shape.

5. The chip element for micro chemical systems according to claim 3, characterized in that said hole into which said lens is inserted is of a circular shape.

6. The chip element for micro chemical systems according to claim 1, characterized by further comprising a seating with which said lens holding section is secured to said chip.

7. The chip element for micro chemical systems according to claim 1, characterized in that the distance between the focus position of said lens and the center point of said groove with respect to the depth direction of said groove is within 15% of the depth of said groove.

8. The chip element for micro chemical systems according to claim 7, characterized in that the distance between the focus position of said lens and the center point of said groove with respect to the depth direction of said groove is within 10% of the depth of said groove.

9. The chip element for micro chemical systems according to claim 1, characterized in that the distance between the focus position of said lens and the center point of said groove with respect to the width direction of said groove is within 20% of the width of said groove.

10. The chip element for micro chemical systems according to claim 9, characterized in that the distance between the focus position of said lens and the center point of said groove with respect to the width direction of said groove is within 15% of the width of the groove.

11. The chip element for micro chemical systems according to claim 1, characterized in that said securing section secures the end part of said optical fiber via an optical fiber holding section adapted to hold said optical fiber.

12. The chip element for micro chemical systems according to claim 11, characterized in that the end part of said optical fiber is secured by bringing said optical fiber holding section into abutment with said lens holding section.

13. The chip element for micro chemical systems according to claim 11, characterized in that said optical fiber holding section is a ferrule.

14. The chip element for micro chemical systems according to claim 12, characterized in that said securing section has a hole into which said optical fiber holding section is inserted.

15. The chip element for micro chemical systems according to claim 14, characterized in that said securing section has a tube of a cylindrical shape.

16. The chip element for micro chemical systems according to claim 14, characterized in that said hole into which said optical fiber holding section is inserted is of a circular shape.

17. The chip element for micro chemical systems according to claim 1, characterized in that the change amount of the distance between said lens and the end part of said optical fiber with respect to the depth direction of said groove is within a predetermined value at every time mounting said lens and the end part of said optical fiber.

18. The chip element for micro chemical systems according to claim 17, characterized in that said predetermined value is a value of 15% of said depth of the groove multiplied by a lens magnification of said lens.

19. The chip element for micro chemical systems according to claim 18, characterized in that said lens magnification is the value of the distance between the principal point of said lens and the end face of said optical fiber divided by the distance between the principal point of said lens and the focus position of said lens.

20. The chip element for micro chemical systems according to claim 1, characterized in that the change amount of the distance between said lens and the end part of said optical fiber with respect to the width direction of said groove is within a predetermined value at every time mounting said lens and the end part of said optical fiber.

21. The chip element for micro chemical systems according to claim 20, characterized in that said predetermined value is a value of 20% of the width of said groove multiplied by a lens magnification of said lens.

22. The chip element for micro chemical systems according to claim 21, characterized in that said lens magnification is the value of the distance between the principal point of said lens and an end face of said optical fiber divided by the distance between the principal point of said lens and the focus position of said lens.

23. The chip element for micro chemical systems according to claim 1, characterized in that said lens holding section has an opening through which an adhesive is fed.

24. The chip element for micro chemical systems according to claim 1, characterized in that said securing section has an opening through which an adhesive is fed.

25. The chip element for micro chemical systems according to claim 1, characterized in that said lens has a chromatic aberration.

26. The chip element for micro chemical systems according to claim 1, characterized in that said lens is a rod lens.

27. The chip element for micro chemical systems according to claim 1, characterized in that said chip is made of glass.

28. The chip element for micro chemical systems according to claim 27, characterized in that said optical fiber is a single mode at the wavelengths of the excitation light and the detection light.

29. A micro chemical system, characterized by using the chip element for micro chemical systems according to claim 1.

30. The micro chemical system according to claim 29, characterized in that said micro chemical system includes a thermal lens spectrometry system and/or a fluorescent detection system.
